(19) United States
(12) Patent Application Publication
(10) Pub. No.: US 2021/0018466 A1
(43) Pub. Date: Jan. 21, 2021

(54) PHOTOACOUSTIC EXPLOSIVES DETECTORS

(71) Applicant: HEWLETT-PACKARD DEVELOPMENT COMPANY, L.P., Spring, TX (US)

(72) Inventors: Viktor Shkolnikov, Palo Alto, CA (US); Steven Barcelo, Palo Alto, CA (US)

(21) Appl. No.: 16/606,013

(22) PCT Filed: Apr. 11, 2018
(86) PCT No.: PCT/US2018/027114

§ 371 Date: Oct. 17, 2019

(51) Int. Cl. G01N 29/02; G01N 29/22; G01N 29/50; G01N 21/17

(52) U.S. Cl. CPC G01N 29/022; G01N 29/222; G01N 2291/02809; G01N 21/1702; G01N 2291/021; G01N 29/50

(57) ABSTRACT

The present disclosure is drawn to a photoacoustic explosives detector, including a sample chamber, an aerosolizing ejector, a light source, and a pressure differential sensor. The sample chamber can include a photoreaction region, and the aerosolizing ejector can be positioned to eject 3 pL to 10 nL droplets of a liquid sample into the photoreaction region. A light source can be directed to emit focused light through the photoreaction region, and a pressure differential sensor can be positioned with respect to the photoreaction region to sense degradation of the droplets exposed to the focused light.

### BACKGROUND

Detection of explosive substances can be useful for occupational health and safety and for countering criminal acts. For example, in some workplaces, an explosive atmosphere can be unknowingly generated and the ability to detect explosive material in the atmosphere can benefit the health and safety of individuals in the workplace. In addition, there are individuals who are motivated to intentionally cause explosions in a manner to inflict damage to persons and property, and the detection of this type of activity to thwart it would benefit the health and safety of many.

### BRIEF DESCRIPTION OF DRAWINGS

It is understood that the following figures are representative of examples of the present disclosure and should not be considered as unduly limiting the scope of the present disclosure.

FIG. 1 schematically illustrates an example photoacoustic explosives detector in accordance with examples herein;

FIG. 2 schematically depicts an example graph showing absorption peaks and wavelengths that is illustrative in describing a photoacoustic explosives detector in accordance with examples herein;

FIG. 3 schematically illustrates degradation of an explosive material and its detection in a photoacoustic explosives detector in accordance with examples herein; and

FIG. 4 schematically illustrates a method of detecting an explosive from a liquid sample in accordance with the present disclosure.

### DETAILED DESCRIPTION

As detecting trace amounts of explosives can be complex and expensive, and as there are a wide variety of explosive materials, some of which lacking in easily detectable signatures, the detection of explosives for occupational safety, security, other purposes can be challenging, particularly when there may be pressure for detection speed, e.g., TSA airport security lines.

In accordance with this, the present disclosure relates generally to photoacoustic explosives detectors. In one example, a photoacoustic explosives detector can include a sample chamber that can include photoreaction region, an aerosolizing ejector positioned to eject 3 pL to 10 nL droplets of a liquid sample into the photoreaction region, a light source directed to emit focused light through the photoreaction region, and a pressure differential sensor positioned with respect to the photoreaction region to sense degradation of the droplets exposed to the focused light. In one example, the aerosolizing ejector can include a thermal fluid jet ejector, a piezoelectric fluid ejector, an acoustic fluid detector, an ultrasonic droplet generator, or a nebulizer. In another example, the aerosolizing ejector can be the thermal fluid jet ejector that can have a jetting frequency of 1 kHz to 50 kHz. In yet another example, an interior space of the sample chamber can be from 0.001 mm³ to 1 cm³, e.g., 100 μm×100 μm×100 μm to 1 cm×1 cm×1 cm, and the photoreaction region can be within the interior space, e.g., the same size as the interior space of the sample chamber or in some instances small than the sample chamber. In a further example, the light source can include a scanning wavelength laser, a xenon lamp, a mercury lamp, a scanning electron beam emitter, a glow bar, a black body emitter, or a light-emitting diode. These light sources can be, for example, associated with a focusing lens assembly. In one example, the light source can include a scanning wavelength laser to emit focused light at from 50 nm to 20 μm. In another example, the pressure differential sensor can include an accelerometer, a pressure transducer, a microphone, or a vibration detector. In yet another example, the pressure differential sensor can be sensitive to pressure waves ranging from 0.3 μPa to 600 Pa.

In another example, a photoacoustic explosives detector can include a sample chamber having an interior volume defined by walls, wherein the interior volume can be from 0.001 mm³ to 1 cm³, e.g., 100 μm×100 μm×100 μm to 1 cm×1 cm×1 cm, and wherein the interior volume encompasses a photoreaction region. The photoacoustic detector can also include a thermal fluid ejector positioned to eject 3 pL to 10 nL droplets of a liquid sample into the photoreaction region, a scanning laser light source directed to emit laser light through the photoreaction region, and a pressure differential sensor positioned with respect to the photoreaction region to sense explosive degradation of the droplets exposed to the focused light.

A method of detecting an explosive material from a liquid sample can include aerosolizing a liquid sample to generate a liquid aerosol in a photoreaction region of a sample chamber, exposing the liquid aerosol to focused light to photoreactively degrade explosive molecules that can be present in the aerosolized sample, and sensing a pressure change that can be associated with degradation of the explosive molecules that can photoreactively degraded within the sample chamber. In one example, the aerosolizing can include thermally ejecting the liquid sample into the photoreactive region. In another example, the focused light can be generated by a light source including a wavelength laser set a wavelength ranging from 50 nm to 20 μm. In yet another example, the aerosolizing can include multiple aerosolizing events, pulsing the focused light through the liquid aerosol. In a further example, the multiple aerosolizing events can be synchronously correlated with a pulse frequency of the focused light.

It is noted that when discussing the photoacoustic explosives detectors and the method of detecting an explosive in a liquid sample each of these discussions can be considered applicable to other examples whether or not they are explicitly discussed in the context of that example unless expressly indicated otherwise. Thus, for example, in discussing a photoreaction region of a sample chamber in a photoacoustic explosive detector, such disclosure is also relevant to and directly supported in the context of other photoacoustic explosive detectors, the method of detecting an explosive in a liquid sample, and vice versa.

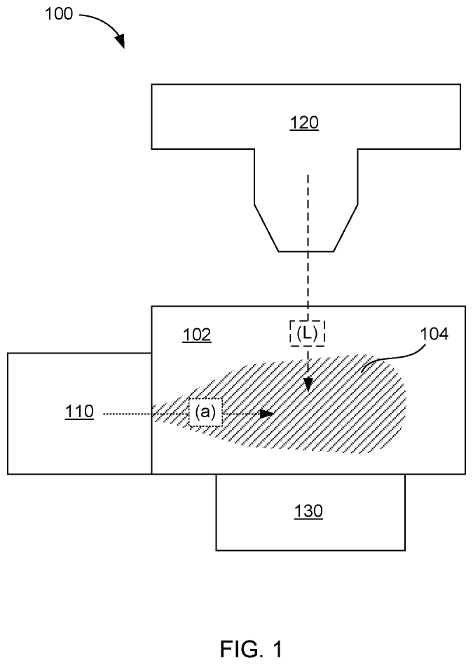

As mentioned, the present examples relate to photoacoustic explosives detectors and methods of detecting an explosive from a liquid sample. The detectors and method presented herein can be utilized for sensing the presence of an explosive material in a liquid sample. As used herein, an “explosive material” refers to a substance that contains an amount of potential energy that can produce an explosion. An exposure material can include substances that can be dormant unless activated by another agent such as light, heat, sound, pressure, another chemical, or the like. Turning to the detector per se, as shown in FIG. 1, the photoacoustic explosives detector 100 can include a sample chamber 102 with a photoreaction region 104. The photoreactive region can be defined by a volume within the chamber where small liquid droplets of a liquid sample can be ejected as an aerosol (a) by an aerosolizing ejector. In some instances, the liquid volume can fill the sample chamber and thus, the photoreactive region fills the sample chamber. In this instance, as shown, the photoreactive region is smaller than the interior size of the sample chamber; however in some instances, the photoreactive region can be the same as the interior of the sample chamber. The system also includes a light source 120 for directing focused light (L) into the photoreactive region (within the sample chamber). The focused light contacting the aerosolized liquid droplets of the sample can thus cause the liquid droplets to combust if there is explosive material contained therein. Upon liquid droplet degradation or combustion, a pressure wave results that may be very small in scale, e.g., from 0.3 μPa to 50 μPa. To read detect the pressure wave, a pressure differential sensor 130 can also be present to detect any small-scale explosions, if any (depending on the sample tested). The area where the focused light interacts or comes into contact with the aerosolized liquid is the location where the small decomposition or explosion may be initiated, and this location can be even smaller than the photoreactive region in some instances, depending on the diameter of the focused light beam compared to the size of the sample chamber and/or photoreactive region.

In further detail regarding the sample chamber and the photoreaction region, an interior space of the sample chamber can be from 0.001 mm³ to 1 cm³, e.g., 100 μm×100 μm×100 μm to 1 cm×1 cm×1 cm, from e.g., 0.125 mm³ to 1 cm³, e.g., 500 μm×500 μm×500 μm to 1 cmμ1 cmμ1 cm, or from about 0.015 mm³ to 1 mm³, e.g., about 250 μm×250 μm×250 μm to 0.1 cm×0.1 cm×0.1 cm. The sample chamber can be defined by walls of a transparent or semi-transparent material to allow the light source to emit a focused light beam into the photoreaction region. In yet other examples, a portion of the sample chamber can be transparent or semi-transparent, e.g., a window, in order to allow the focused light beam to be directed at the photoreaction region. Other arrangements can also be utilized, such as where the light source includes a lens that is integrated with a wall of the sample chamber, or where a light emitting portion of the light source, e.g., laser, is inserted into the sample chamber. In further detail, in FIG. 1, the sample chamber is shown as a rectangular shape. Other shapes may be used, including asymmetric shapes, such as including a sample chamber with one or multiple narrow necks feeding a larger central chamber area, e.g., focused light, aerosolized liquid, or sound waves pass through a narrow necks to or from the larger central chamber. Alternatively, the explosion can be caused to occur in a restricted region and sensed after passing into an expanded region, or vice versa.

As also mentioned, the photodetector can further include an aerosolizing ejector positioned to eject 3 pL to 10 nL droplets of liquid sample into the photoreaction region of the sample chamber. The aerosolizing ejector can aerosolize a portion of a liquid containing a sample for testing and can eject the aerosolized portion into the sample chamber. The aerosolizing ejector can include a thermal fluid jet ejector, a piezoelectric fluid ejector, an acoustic fluid detector, an ultrasonic droplet generator, or a nebulizer. In one example, the aerosolizing ejector can be a thermal fluid jet ejector. In a thermal fluid jet ejector, heating elements can vaporize a small volume of the liquid and create pressure in the liquid that ejects the vaporized sample. In yet another example, the aerosolizing ejector can be a nebulizer. A nebulizer can create a vaporized sample with oxygen, compressed air, or ultrasonic power to produce small aerosolized droplets of the sample.

In some examples, a jetting frequency of the photodetector can be tunable. For example, the aerosolizing ejector can have a jetting frequency ranging from 1 kHz to 50 kHz. In another example, the aerosolizing ejector can have a jetting frequency of from 5 kHz to 45 kHz, from 15 kHz to 30 kHz, from 25 kHz to 50 kHz, from 5 kHz to 20 kHz, or from 1 to 10 kHz. In one example, jetting frequency can be increased by increasing a velocity of the ejection which can occur by increasing energy input to the ejector. Adjusting the jetting frequency can allow the user to match the frequency of ejection with the application of the light source on the aerosolized sample.

The volume of the droplets of the liquid sample ejected from the aerosolizing ejector can also vary. In one example, the volume of the droplets can range from 3 pL to 10 nL. In yet other examples, the volume of the droplets can range from 3 pL to 10 pL, from 50 pL to 1,000 pL, from 100 pL to 10,000 pL, from 3 pL to 500 pL, from 5 pL to 40 pL, or from 250 pL to 750 pL. The droplet volume can be correlated to the nozzle size of the aerosolizing ejector. A smaller sized nozzle can eject smaller droplet volumes; whereas, a larger sized nozzle can eject larger droplet volumes. For example, a 10 μm sized nozzle can eject 10 pL droplets. In some examples, the volume of the droplet can set parameters for the sensitivity of the pressure differential sensor utilized in the device. For example, smaller droplet volumes can be used with sensitive pressure differential sensor; whereas, larger droplet volumes sample can be used in conjunction with a less sensitive pressure differential sensors.

The photoacoustic detector can further include a light source, which can be a light source system with various components or multiple light sources in one example, that can be directed to emit focused light through the photoreaction region. The light source can be used to energize the droplets of the aerosolized liquid sample in the photoreaction region and is not particularly limited. The light source can be any light source capable of degrading explosive molecules in the aerosolized sample. In one example, the light source can include a scanning wavelength laser, a xenon lamp, a scanning electron beam emitter, a glow bar, a black body emitter, a light-emitting diode or a mercury lamp. In one example, the light source can be a scanning wavelength laser. In some examples, the light source can be several lasers that can make up a light source. In other examples, the laser can be a micro-laser.

The light source can be a visible light source, a near ultraviolet source, or a near infrared light source. In one example, the light source can emit focused light onto the aerosolized sample at a wavelength ranging from 50 nm to 20 μm. In yet other examples, the light source can emit focused light on the aerosolized sample at a wavelength ranging from 50 nm to 100 nm, from 1 μm to 20 μm, from 100 nm to 5 μm, from 500 nm to 1 μm, or from 1 μm to 20 μm.

In further detail, in accordance with examples herein, a light source can be used that can emit many discrete wavelengths. There may be explosive materials that can be detonated (at these aerosolized volumes) based on a known wavelength of light at a known minimum intensity. Thus, various wavelengths (e.g., 50 nm to 20 μm) coupled with various minimum energy levels (e.g., 10 femtojoules to 100 nanojoules) can be independently or collectively swept through the aerosolized liquid sample, either using pulsing or using continuous energy, for purposes of determining not just whether a material has an explosive therein, but the explosive's identity. The term “swept” can include a continuous sweeping (without skipping ranges) from one wavelength or wavelength band and/or energy level to the next, or an incremental sweeping from one discrete or specific wavelength or wavelength band and/or energy level to the next, e.g., stepwise, randomized, or in a pattern such as when testing for more likely liquid sample candidates to less likely liquid sample candidates, etc. To illustrate by one specific example, in some circumstances, depending on droplet size, time, wavelength range, pulse frequency, and potentially other factors, pentaerythritol tetranitrate (PETN) can be detonated using a 3,440 nm focused laser light set at 1 picojoule, but at the same wavelength, a 15 femtojoule (fJ) beam of light energy may not be enough to detonate the same liquid. Thus, with all other factors being the same, this material can be rapidly decomposed at a first low detonating energy level compared to a second even lower non-detonating energy level (where decomposition is not detectable). Other liquids can likewise be characterized similarly for evaluation using the photoacoustic explosives detector described herein.

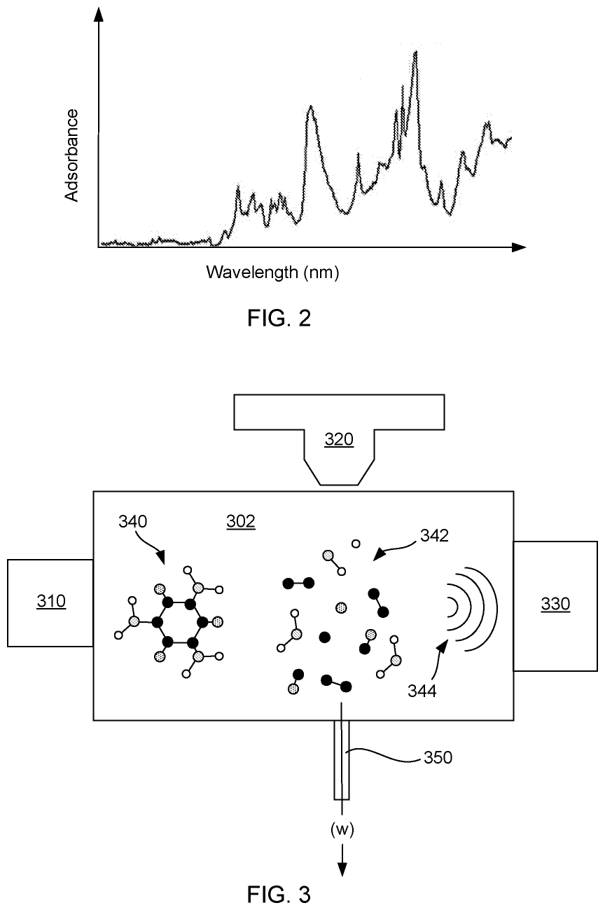

To illustrate by way of a more general example, the pressure level emitted from an explosive or rapid reaction can correspond to a relatively narrow or narrow wavelength of the emitted light, illustrated as an absorption peak. FIG. 2 exemplifies a sample graph of absorption peaks that can correlate with photoacoustic explosives detection described herein. This type of correlation can be used to identify the composition of the explosive material, in one example.

In further detail, as shown in FIG. 3, when a light beam from the light source 320 is directed to the droplets of liquid ejected from the aerosolizing ejector 310 into the photoreaction region of the sample chamber 302, explosive molecules 340 within the droplets can absorb energy from the light beam and can degrade 342 rapidly or combust. This degradation can be due to the volatile nature of the explosive molecules. The degradation can release a pressure wave 344 that can be detected by a pressure differential sensor 330. Notably, the light source, the pressure differential sensor, and the aerosolizing ejector 310 are arranged differently than shown in FIG. 1, and thus, various component arrangements as can be implemented in accordance with examples herein. In one example, the degradation can be decomposition, deflagration, or detonation of the explosive molecules. In one example, the energy from the degradation can amplify the pressure wave that is released.

The pressure differential sensor can be positioned with respect to the photoreaction region so that the pressure differential sensor can measure the pressure wave that is associated with the degradation of the explosive molecules. In one example, the pressure differential sensor can include an accelerometer, a pressure transducer, a microphone, or a vibration detector. In one example, the pressure differential sensor can be a MEMS microphone. A commercially available MEMS microphone is an Infineon 70 dB signal-to-noise ratio microphone (Infineon Technologies, AG, Germany). In yet another example, the pressure differential sensor can be a vibration detector.

A sensitivity of the pressure differential sensor can be sensitive to any of a number of pressure waves, but because the photoacoustic explosives detectors described herein use small volumes, e.g., for practical sampling purposes, for safety, etc., pressure waves ranging from 0.3 μPa to 600 Pa can be detected. In yet other examples, the pressure differential sensor can be sensitive to a pressure level ranging from 0.3 μPa to 250 μPa, from 10 μPa to 10,000 μPa, from 50 μPa to 500 μPa, from 300 μPa to 600 μPa, from 10 μPa to 30 μPa, from 1,000 μPa to 600 Pa, from 10,000 μPa to 400 Pa, or from 1 Pa to 600 Pa. In one example, the pressure wave that is measured can be the log of pressure, e.g. decibels.

The size of the photoacoustic explosives detector can vary; however, in some examples, the photoacoustic explosives detector can be small enough to fit into a user's hand or slightly larger as a hand-held device. In another example, the photoacoustic explosives detector can fit in a 100 cubic inch space, a 64 cubic inch space, a 36 cubic inch space, a 24 cubic inch space, etc. The “space” can define the interior volume of a housing that may be used contain the components described herein. In other examples, the photoacoustic explosives detector can be a larger device such as a table-top photoacoustic explosive detector, or can be modular device where a sample is loaded into fluid container (with or without the aerosolizing ejector), and then the fluid container is fluidly coupled to aerosolizing ejector or the aerosolizing ejector to the sample chamber for testing.

In some examples, the photoacoustic explosives detector can include components to enhance performance and/or to increase sensitivity and allow for a reduction in the overall size of the photoacoustic explosives detector. As mentioned, the photoacoustic explosives detector can be focused to direct a beam of light emitted from the light source onto droplets of the aerosolized sample in the photoreaction region. Focusing can be by way of the use of lenses or lens assemblies, or in other examples, reflectors can be used to focus the electromagnetic energy source, e.g., light, through the photoreactive region.

In further examples, the photoacoustic explosives detector can include a waste conduit 350 as shown in FIG. 3 that can be fluidly coupled to the sample chamber 302. The waste conduit can be configured to receive and remove spent or reliquefied liquid, or waste (w), from the sample chamber. A sample can become spent after it has been hit with an emitted light beam and ignited or exploded, or is found to be non-explosive thereby potentially diluting future samples. Additionally, as aerosolized droplets come in contact with the walls of the sample chamber, they can collect into larger droplets, running down the walls and collecting on a floor of the sample chamber. Thus, removing the spent sample can enhance the general health of the photoacoustic explosives detector and can provide continued future accuracy to the system as a whole. For example, a first portion of the sample can be aerosolized and droplets received into the photoreaction region of a sample chamber to receive a beam of focused light therein. Following photoreaction (or no reaction, depending on the sample) and sensing of the pressure waves using the differential sensor, the droplets collect by gravity, be removed by the waste conduit, and the process can be repeated with a second portion of the sample, and so forth, until the various electromagnetic energy wavelengths of the device been tested (or a subset thereof) have been reliably directed at the aerosolized liquid sample, typically from multiple pulsed aerosolizing events.

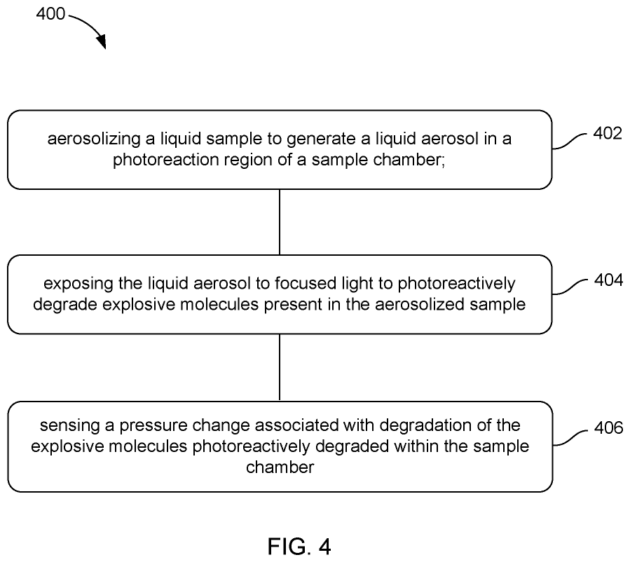

In further detail, in FIG. 4, a method 400 of detecting an explosive in a liquid sample can include aerosolizing 402 a liquid sample to generate a liquid aerosol in a photoreaction region of a sample chamber, exposing 404 the liquid aerosol to focused light to photoreactively degrade explosive molecules present in the aerosolized sample, and sensing 406 a pressure change associated with degradation of the explosive molecules that can photoreactively degraded within the sample chamber. The liquid aerosol can be droplets as described above. As previously discussed, the explosive molecules within the aerosolized sample can degrade as a result of absorbing energy from the light source. The absorbed energy can cause the explosive molecules to decompose, deflagrate, or detonate. The liquid aerosol can be droplets as described above. In one example, the aerosolizing can include thermally ejecting the liquid sample into the photoreactive region. The thermally ejecting can occur from a thermal fluid jet ejector. In another example, the focused light can be generated by a scanning wavelength laser set a wavelength ranging from 50 nm to 20 μm. In a further example, the aerosolizing can include multiple aerosolizing events and the exposing can include pulsing the focused light through the liquid aerosol. In yet another example, the multiple aerosolizing events can be synchronously correlated with a pulse frequency of the focused light. This can ensure a fresh sample is exposed to each pulse of the focused light.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range but also to include all the individual numerical values or sub-ranges encompassed within that range as if each numerical value and sub-range is explicitly recited. For example, a weight ratio range of 1 wt % to 20 wt % should be interpreted to include the explicitly recited limits of 1 wt% and 20 wt %, but also to include individual weights such as 2 wt %, 11 wt %, 14 wt %, and sub-ranges such as 10 wt % to 20 wt %, 5 wt % to 15 wt %, etc.

While the present technology has been described with reference to certain specific examples, various modifications, changes, omissions, and substitutions can be made without departing from the spirit of the disclosure. It is intended, therefore, that the disclosure be limited by the scope of the following claims.

What is claimed is:

1. A photoacoustic explosives detector, comprising:
a sample chamber including photoreaction region;
an aerosolizing ejector positioned to eject 3 pL to 10 nL droplets of a liquid sample into the photoreaction region;
a light source directed to emit focused light through the photoreaction region; and
a pressure differential sensor positioned with respect to the photoreaction region to sense degradation of the droplets exposed to the focused light.

2. The photoacoustic explosives detector of claim 1, wherein the aerosolizing ejector comprises a thermal fluid jet ejector, a piezoelectric fluid ejector, an acoustic fluid detector, an ultrasonic droplet generator, or a nebulizer.

3. The photoacoustic explosives detector of claim 2, wherein the aerosolizing ejector is the thermal fluid jet ejector having a jetting frequency of 1 kHz to 50 kHz.

4. The photoacoustic explosives detector of claim 1, wherein an interior volume of the sample chamber is from 0.001 mm³ to 1 cm³, and the photoreaction region is within the interior volume.

5. The photoacoustic explosives detector of claim 1, wherein the light source includes a scanning wavelength laser, a xenon lamp or a mercury lamp, a scanning electron beam emitter, glow bar, black body emitter, or a light-emitting diode.

6. The photoacoustic explosives detector of claim 5, wherein the light source includes the scanning wavelength laser to emit focused light at from 50 nm to 20 μm.

7. The photoacoustic explosives detector of claim 1, wherein the pressure differential sensor includes an accelerometer, a pressure transducer, a microphone, or a vibration detector.

8. The photoacoustic explosives detector of claim 1, wherein the pressure differential sensor is sensitive to pressure waves ranging from 0.3 μPa to 600 Pa.

9. A photoacoustic explosives detector, comprising:
a sample chamber having an interior volume defined by walls, wherein the interior volume is from 0.001 mm³ to 1 cm³, and wherein the interior volume encompasses a photoreaction region;
a thermal fluid ejector positioned to eject 3 pL to 10 nL droplets of a liquid sample into the photoreaction region;
a scanning laser light source directed to emit laser light through the photoreaction region; and
a pressure differential sensor positioned with respect to the photoreaction region to sense explosive degradation of the droplets exposed to the focused light.

10. The photoacoustic explosives detector of claim 9, wherein the sample chamber is fluidly coupled to a waste conduit to receive and remove spent or reliquefied liquid sample from the sample chamber.

11. A method of detecting an explosive material in a liquid sample, comprising:
aerosolizing a liquid sample to generate a liquid aerosol in a photoreaction region of a sample chamber;
exposing the liquid aerosol to focused light to photoreactively degrade explosive molecules present in the aerosolized sample; and
sensing a pressure change associated with degradation of the explosive molecules photoreactively degraded within the sample chamber.

12. The method of claim 11, wherein the aerosolizing comprises thermally ejecting the liquid sample into the photoreactive region.

13. The method of claim 11, wherein the focused light is generated by a light source including a scanning wavelength laser set at a wavelength ranging from 50 nm to 20 μm.

14. The method of claim 13, wherein aerosolizing includes multiple aerosolizing events, and exposing includes pulsing the focused light through the liquid aerosol.

15. The method of claim 14, wherein the multiple aerosolizing events are synchronously correlated with a pulse frequency of the focused light.
